(19) United States
(12) Patent Application Publication
(10) Pub. No.: US 2003/0156213 A1
(43) Pub. Date: Aug. 21, 2003

(54) Small-size imaging appartaus, in particular photographic appliance or camera

(76) Inventors: Elko Doering, Morigen (CH); Joachim Grupp, Enges (CH); Beat Pfefferli, Thielle Wavre (CH)

Correspondence Address: SUGHRUE MION, PLLC, 2100 PENNSYLVANIA AVENUE, N.W., WASHINGTON, DC, 20037, US

(21) Appl. No.: 10/343,222

(22) PCT Filed: Jul. 23, 2001
(86) PCT No.: PCT/EP01/08532

(30) Foreign Application Priority Data
Aug. 11, 2000 (EP) 00202834.8

(51) Int. Cl. H04N 5/225

(52) U.S. Cl. 348/340; 348/375

(57) ABSTRACT

The image recording apparatus (3) of small dimensions includes a sensor (4) and a lens assembly formed of focussing lenses (8, 9, 10) arranged in a frame (12). The sensor is arranged on a first face (16) of a support (18), which has an aperture (20) facing which is arranged the photosensitive surface (6) of said sensor. On the other side, on the second face (22) of the support is arranged the lens assembly frame such that the lenses are substantially aligned with the support aperture and the photosensitive surface. The sensor is formed of a semiconductor substrate defining the photosensitive surface and having at the periphery thereof pads or bumps for electric contact with the support.

The present invention concerns an image recording apparatus of small dimensions, particularly a camera or video camera, wherein there is provided a sensor formed of a plurality of pixels used for detecting images. This apparatus includes at least one focussing lens whose optical axis substantially intersects the geometric centre of the photosensitive surface of the sensor.

In particular, the image recording apparatus according to the invention is intended to be incorporated in a multi-functional portable device, particularly a mobile telephone, a watch or a portable microcomputer.

There is known from U.S. Pat. No. 5,130,804 an image recording apparatus including a sensor, a lens arranged in a frame, and a support with an aperture opposite which, on either side of said support, the lens and a photosensitive surface of said sensor are arranged. The sensor itself is formed of a substrate defining the photosensitive surface, this substrate being arranged at the bottom of a case to which it is electrically connected in a conventional manner. This case includes electric connections connecting the substrate to external contact pads of the case to allow electrical connection to said support on which electronic units are mounted. Moreover, the case has a recess in the wall of its aperture for installing a glass plate used to close said aperture (see FIGS. 4, 6 and7).

The apparatus described above has the drawback of being relatively expensive since the sensor itself is relatively complex. Further, the electric connection between the photosensitive surface substrate and the support for the electronic units is made in two steps requiring a first connection using bonding leads beyond the upper face of the substrate and the bottom of the case. This connection is fragile. Moreover, the sensor has relatively large dimensions, in particular the thickness thereof.

An object of the present invention is to overcome the aforementioned drawbacks by providing an image recording apparatus having minimal dimensions, which can easily be integrated into a portable device.

Another object of the invention is to provide such an apparatus wherein the electric connections between the pixels of the sensor and the electronic unit for processing and/or exploiting the electronic signals provided by the pixels are established easily and reliably.

Finally, another object of the invention is to provide an apparatus of this type that is compact and easy to assemble for inexpensive manufacture.

The apparatus according to the invention has a minimum height and a high level of rigidity. The sensor and its electric connections which form the fragile part of the apparatus are properly protected and reliable. Further, the electric connections from the sensor to the peripheral electronic units are established without weld wires.

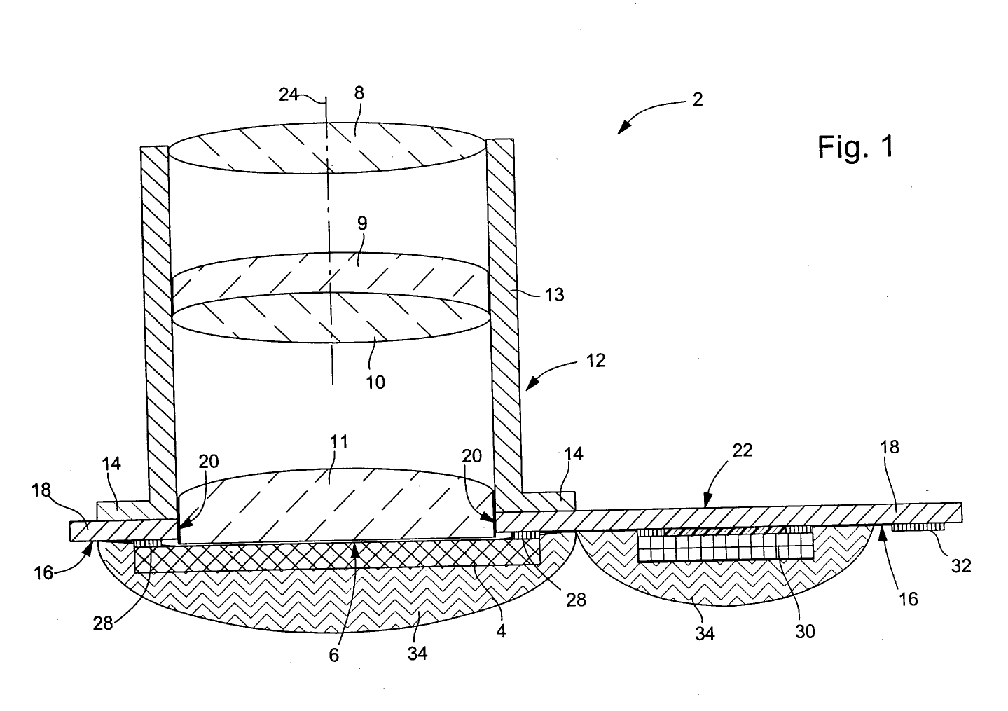

The present invention will be described in detail hereinafter using the following description, made with reference to FIG. 1 given by way of non-limiting example and schematically showing a preferred embodiment of an image recording apparatus.

FIG. 1 schematically shows an image recording apparatus 2 forming a compact and autonomous module. However, it is intended to be integrated in a portable device, particularly a telephone or object worn on the wrist like a watch. This apparatus is formed of an image sensor 4, having a photosensitive surface 6 and a lens assembly including focussing lenses 8, 9, 10 and an optical element 11 mounted in a frame 12 defining a tube 13 open at both of its ends and an end shield 14 located at the inner end of the tube, i.e. on the sensor side. Sensor 4 is mounted on the lower face 16 of a support 18 that has an aperture 20 of substantially equal or larger dimensions to those of photosensitive surface 6 which is located facing this aperture and substantially centred thereon. End shield 14 is secured to upper face 22 of support 18 such that optical axis 24 of lenses 8 to 10 passes substantially through the geometrical centre of the aperture and of the photosensitive surface.

Optical element 11 here forms a lens, but it may also be a simple transparent plate forming a UV filter for example.

Frame 12 can be secured to support 18 in various ways available to those skilled in the art, particularly by bonding. Various positioning means can be provided, in particular pins arranged in the substrate or in the end shield. The frame can also be screwed on or mounted by other equivalent means.

Sensor 4 is formed of a semiconductor substrate at the surface of which are arranged pixels defining photosensitive surface 6. These pixels are connected by electric paths to electric contact bumps 28 with corresponding pads arranged on lower face 16 of the support. Various conductive paths connecting the contact pads to sensor 4 are arranged on this face 16, with at least one electronic unit 30 arranged on said face 16. Peripheral contact pads 32 can also be provided for supplying the images processed or partially processed to exploitation means, particularly display means for images recorded by apparatus 2. The electric contact bumps or pads can be replaced, in other variants, respectively by pads or bumps.

Sensor 4 and electronic unit 30 are protected by means of a resin 34. This resin 34 also rigidifies the back part of support 18 and holds the electric connections between the contact pads arranged on said support and connection pads or bumps 28 of the sensor. It will be noted that sensor 4 can have only contact pads formed of a fine surface metallisation, the electric connection being achieved by means of an anisotropic conductive adhesive or another intermediate conductor known to those skilled in the art.

It will also be noted that in another embodiment optical element 11 is not provided.

It will be noted finally that support 18 can advantageously have a flexible portion able to bend between a first part supporting the sensor and the lens assembly and a second part carrying other units, particularly electronic unit 30. This enables the second part to be folded down under the first part to obtain a very compact apparatus where unit 30 is located facing sensor 4, in the extension of the lens assembly.

1. Image recording apparatus (2; 3) of small dimensions formed of at least one lens assembly (8, 9, 10), a support (18) having an aperture (20) and a sensor (4) formed of a substrate having a photosensitive surface (6), said optical lens and said photosensitive surface being located facing said aperture respectively on either side of said support, which includes on a first face (16) conductive paths and first electric contact pads or bumps, characterised in that said sensor includes on said substrate at the periphery of said photosensitive surface second contact pads or bumps (28) located facing said corresponding contact pads or bumps of said support to which they are electrically connected.

2. Apparatus according to claim 1, characterised in that said sensor is integrated in a semiconductor substrate on one face of which are arranged said photosensitive surface and said second contact pads or bumps.

3. Apparatus according to any of the preceding claims, characterised in that said at least one lens (8, 9, 10) is arranged in a frame (12) open at both of its ends and secured to a second face (22) of said support opposite said first face (16).

4. Apparatus according to claim 3, characterised in that there is provided an optical element (11) formed of a second lens and/or a filter which penetrates said aperture of said support and said frame at least partially.

5. Apparatus according to any of the preceding claims, characterised in that there is provided at least one electronic unit (30) for processing and/or exploiting the electric signals supplied by said sensor, said electronic unit being arranged on said first face (16) of said support (18).

6. Apparatus according to any of the preceding claims, characterised in that said sensor is protected by a resin (34) deposited thereon and on said first face of said support.
